(19) United States
(12) Patent Application Publication
(10) Pub. No.: US 2008/0277272 A1
(43) Pub. Date: Nov. 13, 2008

(54) Methods and Apparatuses for Making Liquids More Reactive

(76) Inventors: David Kyle Pierce, Elkton, MD (US); David A. Bryce, Elkton, MD (US); Mark G. Mortenson, North East, MD (US)

Correspondence Address: MARK G. MORTENSON, POST OFFICE BOX 310, NORTH EAST, MD, 21901-0310, US

(21) Appl. No.: 12/159,869

(22) PCT Filed: Jan. 3, 2007
(86) PCT No.: PCT/US07/00168

§ 371 Date: Jul. 2, 2008

Related U.S. Application Data
(60) Provisional application No. 60/755,933, filed on Jan. 3, 2006.

(51) Int. Cl. B01J 19/08

(52) U.S. Cl. 204/164; 204/176

(57) ABSTRACT

This invention relates generally to novel methods for affecting, controlling, and/or directing various reactions with and in various liquids (such as water) by creating an energy field within and/or juxtaposed to at least one surface of said liquid. An important aspect of the invention involves the creation of a plasma, which plasma is created between at least one electrode located above the surface of the liquid and at least a portion of the surface of the liquid itself, which functions as at least one second electrode. In order to permit at least a portion of the surface of the liquid to function effectively as a second electrode, at least one additional electrically conducting electrode is typically located within (e.g., at least partially submerged within) said liquid. The plasma results in a restructuring of the liquid and/or the presence of at least one active species within said liquid.

### FIELD OF THE INVENTION

This invention relates generally to novel methods for affecting, controlling, and/or directing various reactions with and in various liquids (such as water) by creating an energy field within and/or juxtaposed to at least one surface of said liquid. An important aspect of the invention involves the creation of a plasma, which plasma is created between at least one electrode located above the surface of the liquid and at least a portion of the surface of the liquid itself, which functions as at least one second electrode. In order to permit at least a portion of the surface of the liquid to function effectively as a second electrode, at least one additional electrically conducting electrode is typically located within (e.g., at least partially submerged within) said liquid. The plasma results in a restructuring of the liquid and/or the presence of at least one active species within said liquid.

### BACKGROUND OF THE INVENTION

Many techniques have been utilized to render liquids, such as water, more reactive. These techniques include adding various chemicals to the liquid, creating electric and/or magnetic fields in and/or around said liquids, various pressure conditions, creating various plasmas around the surface of said liquids, etc. These techniques all strive to change the properties of the liquid in some desirable manner. Specifically, many commercial and industrially important processes rely on liquids of various compositions to achieve desirable results.

For example, changing the reactive properties of water has achieved significant attention. Water is one of the most important, as well as most complicated, structures known to man. While much is known about a single water molecule, little is understood about dimers, trimers, oligimers, clusters (e.g., micro and macro), polymers, and long range structure(s) of water, all of which affect the performance of water in biological, chemical, and physical processes. Many processes are known in the art for the creation of ozone by, for example, the creation of plasmas, over or near liquid (e.g., water) surfaces; and thereafter mixing or dissolving the created ozone into the liquid.

In general, plasmas cover a large range of voltage and amperage conditions. The amount of volts and amps used to create the plasma typically defines the type of plasma created. In this regard, FIG. 1 shows, in general, several different plasma nomenclatures used to describe different combinations of volts and amps used to form different plasmas. In particular, FIG. 1 shows classic voltage-current characteristics of typical DC intermediate-pressure electrical discharge in tubes. While all of the noted discharges can be used to affect solids and/or liquids, many of the known “corona” or “glow discharges” are often associated with the creation of ozone in/or near liquids, such as water, and are used to dissolve ozone into the water.

In addition, plasmas are powered (or created) by DC sources, radio frequency (“RF”) sources, and AC sources as well. Different terminologies or terms are used to describe different plasmas, and such terms often provide insight into important physical/chemical/thermal characteristics and features of such plasmas. For example, a true “corona” or “corona discharge” or “corona arc” or “corona plasma” is generated in a strong electric field by using, for example, sharp points or fine wires as at least one electrode. The visible portion of a true corona discharge or corona plasma occurs in the region within a critical radius radiating from the sharp point or wire; wherein the electric field that is created is equal to, or greater than, the breakdown electric field of the medium (e.g., a gas or a liquid) surrounding the sharp point or electrode.

A true corona typically occurs in a gas phase. A true corona is not created between two parallel smooth plates, nor does a true corona occur in the presence of an insulating coating over a conductor giving rise to some sort of plasma. In particular, dielectric barrier discharge is often confused with corona arc discharge. In this regard, dielectric barrier discharge often occurs, for example, when using parallel plate electrodes or annular cylindrical electrodes, wherein at least one electrode will be insulated with a dielectric barrier so as to prevent real currents from flowing from the discharge volume to the electrodes and power supply. Dielectric barrier discharges operating at about one atmosphere have histories dating back to the 1800s. In particular, dielectric barrier discharges typically occur in the space between two electrodes, at least one of which is covered with an insulated dielectric coating. DC sources, AC sources, or pulsed high voltage can be applied to electrode pairs to stimulate electron emission from, and between, the electrodes. Corona arc discharges, however, differ from dielectric barrier discharge.

In particular, as stated above, corona discharges are typically created in regions of high electric field surrounding sharp points, fine wires, edges of metal sheets, etc. In this regard, an exemplary atmospheric pressure corona arc discharge is shown in FIG. 2. In particular, FIG. 2 shows a top perspective view of an atmospheric pressure corona arc discharge between a sharp point on, for example, the end of a wire, and a second electrode or a grounded structure. In particular, a high voltage from a high voltage power supply results in the creation of an active radius of interaction between, for example, the tip of a fine wire and an electrode or grounded structure. The active region or active volume is where the radial electric field will fall to the breakdown electric field of the gas. In other words, the active volume is the area where ionization, excitation, and the production of active species will occur. Depending on the current and voltage source, the active region may create visible electromagnetic energy, which can be seen with the naked eye, as well as audible sound. These types of coronas typically involve voltages from a few thousand volts to several tens of kV with currents varying from 1 to 100 mA/m. Actual or true coronas seldom operate at power levels above 1 kW. When coronas are created by, for example, an AC source, successive diverging waves of positive and negative thermalized ions will propulgate away from a source electrode.

An example of utilizing plasmas to affect water is shown in U.S. Pat. No. 5,478, 533 to Inculet. This patent discloses a water treatment apparatus whereby ozone generation and water treatment take place simultaneously. In particular, an apparatus is disclosed which provides an ozone generator in which a body of water having a free surface 16 is spaced apart from the electrode 18 covered by an insulator 20. An alternating high voltage is impressed on the insulated electrode 18 facing the free surface 16. When such alternating potential is applied to the electrode 18 over the water surface 16, a plurality of Taylor cones 38 appear over the entire water surface 16. Discharges occur at the tip of each cone and such discharges are disclosed as generating ozone at the surface of the water. The ozone generated at the surface of the water is dissolved into the water by various means thus assisting in sterilizing the water.

Further, U.S. Pat. No. 6,749,759 to Denes, et al, disclose a method for disinfecting a dense fluid medium in a dense medium plasma reactor, In particular, Denes, et al, disclose decontamination and disinfection of potable water for a variety of purposes. Denes, et al, disclose various atmospheric pressure plasma environments, as well as gas phase discharges, pulsed high voltage discharges, etc. In particular, Denes, et al, disclose the use of multiple spark discharges for the inactivation of microorganisms in water. Denes, et al, use a first electrode comprising a first conductive material immersed within the dense fluid medium and a second electrode comprising a second conductive material, also immersed within the dense fluid medium. Denes, et al then apply an electric potential between the first and second electrodes to create a discharge zone between the electrodes to produce reactive species in the dense fluid medium. Also disclosed is the use of an antimicrobial material, such as silver, as one or both of the electrodes.

Also known in the art is the generation of ozone by pulsed-corona discharge over a water surface as disclosed by Petr Lukes, et al, in the article, “Generation of ozone by pulsed corona discharge over water surface in hybrid gas-liquid electrical discharge reactor”, J. Phys. D: Appl. Phys. 38 (2005) 409-416. Lukes, et al, disclose the formation of ozone by pulse-positive corona discharge generated in a gas phase between a planar high voltage electrode (made from reticulated vitreous carbon) and a water surface, said water having an immersed ground stainless steel “point” mechanically-shaped electrode located within the water and being powered by a separate electrical source.

The art also recognizes plasma electrolysis, which is a generic term used to describe a variety of high voltage electrochemical processes, all of which feature plasma-charge phenomena occurring at electrode-electrolyte interfaces. These plasma discharges occur at metal/electrolyte interfaces when the applied voltage exceeds the breakdown voltage (i.e., a critical value typical several hundred volts to several thousand volts). Various discharge phenomena will occur in both a positive and negative biasing of a metal electrode and depending upon the particular compositions of the electrode/electrolyte combination as well as polarization parameters, the discharge phenomena will vary widely in appearance from a steady uniform glow surrounding the electrode to discreet, short-lived microdischarges moving rapidly across its surface. Plasma electrolysis is also being utilized for surface engineering of many different materials including metals, polymers, etc.

Also known in the art are solvated electrons which were first observed in liquid ammonia in the late 1800s. When the solvent comprises water, the solvated electron is often referred to as a “hydrated electron”. It is believed that hydrated electrons are important in a plurality of physical, chemical, and biological processes. The precise physical structuring or location(s) of hydrated electrons in water is subject to debate and has not been completely quantified. For example, traditional views of the locations or structure of hydrated electrons in water include a hydrated electron being confined within a small void created by a surrounding cluster of water molecules. However, an alternative structure may be that the hydrated electron is bound to the surface of one or more water clusters of varying size(s). Accordingly, it is possible to view a hydrated electron as being an electron located in a cavity formed by surrounding water molecule(s) so that the description of the hydrated electron state structure could be, in one sense, analogous to that of a hydrogen atom. However, the exact physical structure of a hydrated electron is probably more complex than anyone currently realizes.

Hydrated electrons (and the physical water structures associated therewith) can occur when an excess of electrons are present in liquid water. While much is still to be learned of hydrated electrons, it is clear that their presence enhances the reactivity of water molecules. It is not clear how many water molecules are affected by hydrated electrons, but there may be as few as three water molecules involved with each hydrated electron, or as many as a few thousand of such molecules. Many efforts have recently been made to understand the varying changes in the structure of water or water clusters as a function of, for example, the presence of hydrated electrons.

Some reference has been made to hydrated electrons being “water buckeyballs” (see work of Prof. Keith Johnson at the Massachusetts Institute of Technology). Johnson, et al, have studied electronic structure and low frequency vibrational mode(s) of water molecules that have been affected by hydrated electrons.

Further, very specific uses for modified water molecules, known as clusters or macroclusters, include work by Johnson et al (see U.S. Pat. Nos. 5,800,576 and 5,997,590). These patents disclose water clusters that contain reactive oxygens and the patents speculate that the oxygens can contribute to more desirable and/or more complete fuel combustion. Accordingly, the importance or commercial significance of ordering certain water structures has been generally recognized.

The present invention satisfies a long felt need of utilizing a relatively simple process and apparatus for favorably modifying the properties of any liquids, including water (e.g., any liquid as long as the liquid is not combustible under the process conditions of the invention). Accordingly, for the first time ever, liquids can be made desirably more reactive by a simple and unique process.

### SUMMARY OF INVENTION

The present invention is generally directed to modifying the properties of a liquid (e.g., water) by creating an energy field within and/or juxtaposed to at least one surface of said liquid. An important aspect of the invention involves the creation of a plasma, which plasma is created between at least one electrode located above at least a portion of the surface of the liquid and at least a portion of the surface of the liquid itself, which surface effectively functions as at least one second electrode (or a plurality of second electrodes). In particular, in order to permit the surface of the liquid to effectively function as at least one second electrode, at least one electrically conductive electrode is placed at least partially below the surface of the liquid which is to be modified/treated. An additional at least one electrode is placed above at least a portion of liquid which is to be treated. A voltage source is connected between the at least one electrode located above the surface of the liquid and the at least one electrode located at least partially below the surface of the liquid. The electrode(s) may be of any suitable configuration which results in the creation of a corona or glow discharge between the electrode(s) located above the surface of the liquid and at least a portion of the surface of the liquid itself. In this regard, corona discharge is often associated with fine points or sharp edges. An appropriate voltage is applied between the electrode pair(s) such that a plasma or corona or corona arc is created between at least a portion of the surface of the liquid and the electrode(s) located above the surface of the liquid.

Specifically, the electrode or electrode combination that is placed below the surface of the liquid takes part in the creation of corona or corona plasma by providing voltage and current to the liquid or solution, but the plasma or corona is actually located between the electrode(s) located above the surface of the liquid and one or more portions of the liquid surface itself. In this regard, a corona discharge or glow discharge can be created between the at least one electrode located above at least a portion of the surface of the liquid when a breakdown voltage of the gas or vapor between the electrode(s) and the surface of the water is achieved.

In a preferred embodiment of the invention, when the liquid comprises water, the gas between the surface of the water and the electrode(s) above the surface of the water comprises air. The breakdown electric field at standard pressures and temperatures for dry air is about 3 MV/m or about 30 kV/cm. Thus, when the local electric field around a point or relatively fine wire exceeds about 30 kV/cm, a corona arc will result in dry air. Equation (1) gives the empirical relationship between the breakdown electric field “E_{c}” and the distance “d” (in meters) between two electrodes:

$${E}_{c} = 3000 + \frac{1.35}{d} kV \text{/} m$$

Of course, the breakdown electric field “E_{c}” will vary as a function of the gas located between electrodes. In this regard, in the preferred embodiment of water, treating/modifying water vapor will be present in the air between the electrodes (i.e., between the electrode above the surface of the water and the water surface itself) and such water vapor will affect the breakdown electric field required to create a corona, therebetween. The electric field strengths are typically at a maximum at a surface of an electrode and decrease with increasing distance therefrom. In all cases involving creation of a corona arc, a portion of the volume of gas between electrode(s) located above a surface of a liquid and at least a portion of the liquid surface itself will contain a sufficient breakdown electric field to create a corona. In this regard, FIGS. 3, 6, and 7 show a point source electrode 10 located a distance “d” above the surface 20 of a liquid 21. A corona 30 is generated between the electrode 10 and the surface 20 when an appropriate power source is connected between the electrode 10 and the electrode 11, which electrode 11 is at least partially below the surface 20 of the liquid 21. The corona discharge region 30, in this embodiment, will typically take the shape of a cone-like structure. The volume of the corona 30 will vary depending on the distance “d”, composition of the electrode 11, the voltage source (DC, AC, RF), the volts applied, the amps applied, the composition of the gas between electrode 10 and the surface 20 of the liquid 21, temperature, pressure, etc.

The composition of the electrodes involved in the creation of the corona 30 of FIGS. 3, 6, and 7 are preferably metallic, but may be made out of any suitable material. In this regard, while the creation of a corona discharge in air above a water surface will, typically, produce ozone, as well as small amounts of nitrogen oxide and other components as well, the corona discharge actually contacts the water surface due to the apparatus configuration shown in FIGS. 3, 6, and 7. In this arrangement, it is clear that any metal from the electrode 10 will probably be “sputtered” onto and/or into the liquid (e.g., water). Accordingly, elementary metal or metal oxides will be found in the liquid. Thus, depending on field strength, electrode composition, etc., greater or lesser amounts of metal may be found in the liquid. In certain situations, the metal found in the liquid may have very desirable effects, in which case relatively large amounts of metal will be desirable; whereas in other cases, metals found in the liquid may have undesirable effects, and thus minimal amounts of metal would be desired. Accordingly, electrode composition can play an important role in the quality of the liquid (e.g., water) that is formed.

Still further, with regard to FIGS. 3, 6, and 7 the electrodes 10 and 11 may be of similar composition or completely different compositions. In this regard, it is possible for the electrode 11 to also donate metallic constituents to the liquid 21.

In another preferred embodiment of the invention, the location or distance “Y” of the electrode(s) 11 away from the electrode(s) 10 should be greater than the distance “d” between the tip 12 of electrode 10 and the surface 20 of the liquid 21, in order to prevent an arc or formation of a corona occurring between the electrode 10 and the electrode 11.

The power applied may be any suitable power source which creates a desirable corona 30 (shown in FIGS. 3, 6, and 7). In a preferred mode of the invention, alternating current voltage is utilized. In particular, the combination of electrode(s) components, physical shape of the electrode(s), the distance “d” between the electrode tip 12 above the liquid surface 20, the shape of the electrode(s) 10, the composition of the gas between the electrode tip 12 and the surface 20, all contribute to the design and thus power requirements (e.g., breakdown electric field) required to obtain a corona plasma discharge between the surface of the liquid 20 and the electrode tip 12.

The number of electrode(s) (in reference to FIGS. 3, 6, and 7) provided relative to the surface 20 of the liquid 21 is a matter of engineering design and/or process rate or efficiency. In this regard, depending on the composition of liquid, the aeral surface of the liquid 20, the size and/or composition of the container 40 housing the liquid 20, the distance “d”, the minimal distance “Y” required between the electrode(s) 10 and electrode(s) 11 (so as not to create discharge therebetween), the desired rate of reaction or change within the liquid 21, the power levels applied between the electrode(s) 10 and 11, all contribute to electrode design and number of desired electrode(s) 10/11 to be present in any system. For example, important parameters discussed above include the creation of a coronal volumetric discharge area 30. The volume 30 of existing corona discharge is a function of all the elements discussed above herein. The rate at which the coronal discharge 30 favorably influences the liquid 21 is a function of all the different parameters discussed above herein. Accordingly, it will be clear to an artistan of ordinary skill, that various electrode designs 10/11 are suitable. In this regard, FIG. 4 shows a number of suitable electrode designs for use with the present invention. The precise electrode composition, design, location, etc., all contribute to rates at which the liquid 21 is modified by the corona arc discharge process according to the present invention, as well as actual modifications of the liquid itself.

Accordingly, the corona arc plasma created according to the conditions of the present invention, can result in a very rapid change in the properties of the liquid with which the corona arc is in contact with. In particular, when the liquid comprises water, by practicing the process of the present invention the measured pH and measured conductivity of the water changes very rapidly (discussed in greater detail later herein) suggesting significant changes have occurred within the water. Water having a lower pH, after having been treated according to the techniques of the present invention, can be very desirable for subsequent interactions involving the water. In particular, the lowering of the pH suggests the presence of, for example, at least one highly reactive species (e.g., electrons) and the possibility of creating a strong reducing environment. Accordingly, wherever a strong reducing environment would be desirable within a liquid, the present invention may provide some significant benefits.

In another preferred embodiment of the invention, the creation of a plasma or corona discharge utilizing the surface of the liquid may comprise a continuous treatment, a semi-continuous treatment, or may occur only a single time before, during, or after other processing steps involving the liquid. Specifically, the liquid that is to be treated according to the present invention may be exposed to a corona arc, thereby altering its properties; and such altered liquid may thereafter take part in subsequent reactions (e.g., chemical, biological and/or physical).

Alternatively, liquid(s) may be exposed to a first corona arc treatment or set of corona arc treatments and thereafter be involved in one or more reaction(s) (e.g., chemical, biological and/or physical) and thereafter be exposed to another corona arc treatment. Still further, liquid(s) may be exposed substantially continuously, to a corona arc, or set of corona arc treatments, the intensity of which could be varied, as desired, or could be substantially continuous, while said liquid(s) are involved in various reactions(s) (e.g., chemical, biological and/or physical). The length of time of exposure to one or more corona arc discharge(s), as well as the intensity of said corona discharge(s), are adjustable and can be controlled such that very specific modified properties of the liquid can be achieved. For example, liquids processed according to the present invention can be used in subsequent or substantially continuous reactions with other species, whereby the reaction rate and/or reaction(s) or reaction products themselves are improved.

The combination of electrode design, electrode composition, power source, system design (e.g., number and location of electrodes relative to the surface of the liquid), continuous processing, semi-continuous processing, batch processing, composition of gas between the electrode and the surface of the liquid, etc., all contribute to the system design and power requirements. In general terms, whenever an appropriate plasma or cotona/glow discharge can be created between a desirable electrode composition/design and the surface of the liquid, the liquid can be modified in a desirable manner. For example, when the liquid to be treated comprises substantially pure water (e.g., less than 1 ppm total dissolved solids) at a substantially neutral pH, the treated water will thereafter have a measured pH which is significantly lower than the starting pH (along with a higher measured conductivity), thus making the water more reactive in many reaction processes.

### BRIEF DESCRIPTION OF THE FIGURES

FIG. 1 shows a classic voltage and current diagram for DC intermediate pressure electrical discharges within a tube.

FIG. 2 shows a corona generated from a sharp point and the active volume of corona generated from said sharp point.

FIG. 3 shows a schematic cross-section of one embodiment according to the invention.

FIG. 4 shows various electrode designs compatible with the teachings of the present invention.

FIG. 5 shows probes with the pH conductivity meter used in the examples in the present invention.

FIG. 6 shows a perspective view of the apparatus used according to the present invention; and FIG. 6a shows a close-up view of a portion of the apparatus of FIG. 6.

FIG. 7 shows an alternative embodiment of the invention.

FIGS. 8a and 8b show the effect on pH and conductivity, respectively, when practicing the invention shown in FIG. 6 and utilizing silver electrodes.

FIGS. 9a and 9b show the effect on pH and conductivity, respectively, when practicing the invention shown in FIG. 6 and utilizing zinc electrodes.

FIGS. 10a and 10b show the effect on pH and conductivity, respectively, when practicing the invention shown in FIG. 6 and utilizing zinc electrodes and a higher current transformer.

FIG. 11a shows a comparison of pH for the examples corresponding to FIGS. 8, 9, and 10; FIG. 11b shows a comparison of the conductivity for the examples corresponding to FIGS. 8, 9, and 10; and FIG. 11c shows a comparison of the voltages used in the embodiments corresponding to FIGS. 8, 9, and 10.

FIG. 12 is a UV-Vis spectra of the sample corresponding to FIGS. 8a and 8b.

FIG. 13 is a UV-Vis spectra of the sample corresponding to FIGS. 9a and 9b.

FIG. 14 is a UV-Vis spectra of the sample corresponding to FIGS. 10a and 10b.

FIG. 15a and 15b show the effect on pH and conductivity, respectively, when practicing the invention shown in FIG. 6 and utilizing silver electrodes.

FIG. 16a and 16b show the effect on pH and conductivity, respectively, when practicing the invention shown in FIG. 6 and utilizing zinc electrodes.

FIG. 17a and 17b show the effect on pH and conductivity, respectively, when practicing the invention shown in FIG. 6 and utilizing zinc electrodes and a higher current transformer.

FIG. 18a shows a comparison of pH for the examples corresponding to FIGS. 15, 16, and 17; FIG. 18b shows a comparison of the conductivity for the examples corresponding to FIGS. 15, 16, and 17; and FIG. 18c shows a comparison of the voltages used in the embodiments corresponding to FIGS. 15, 16, and 17.

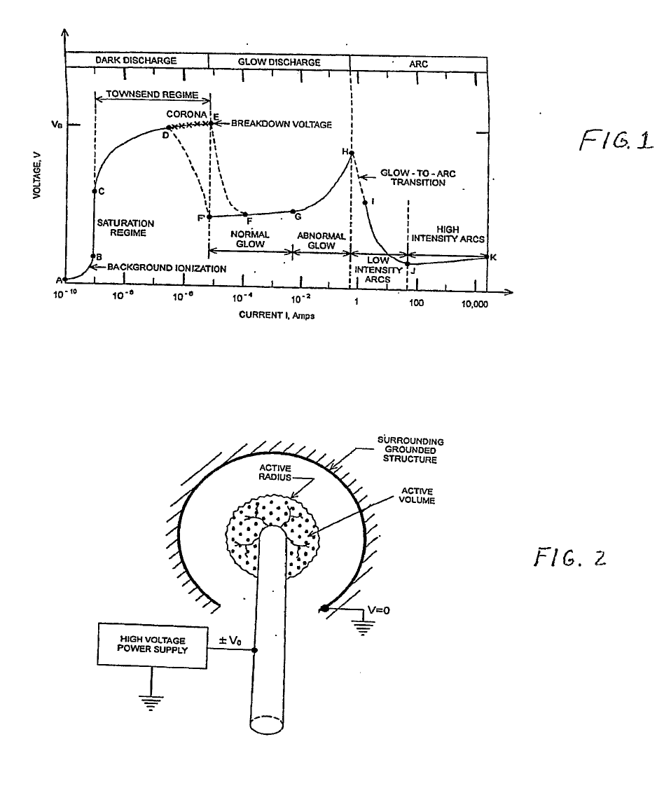

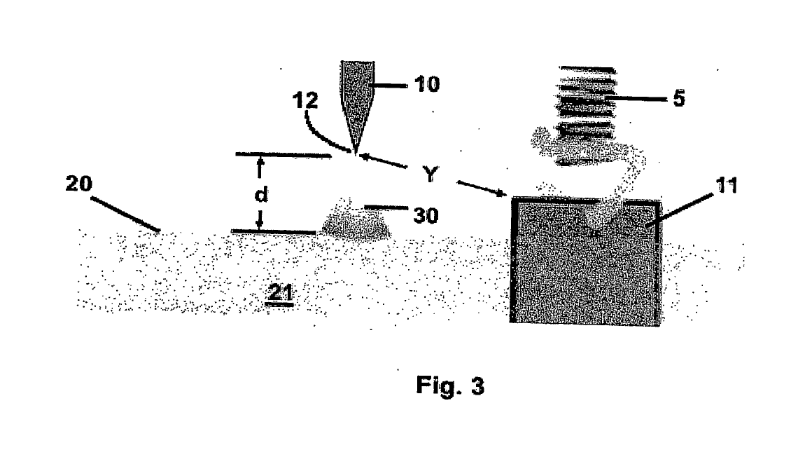

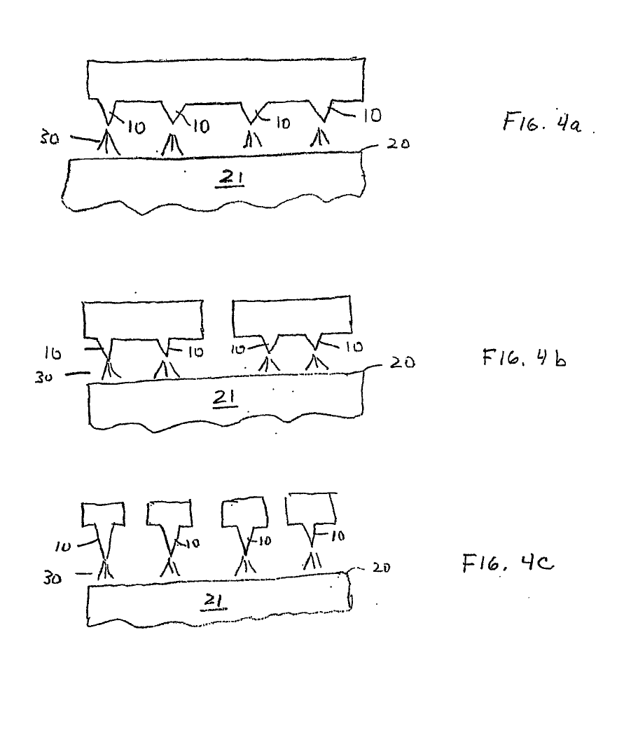

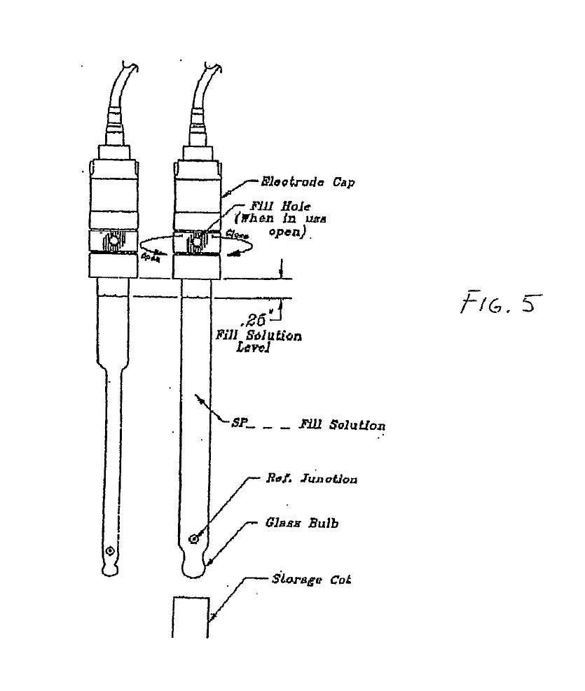

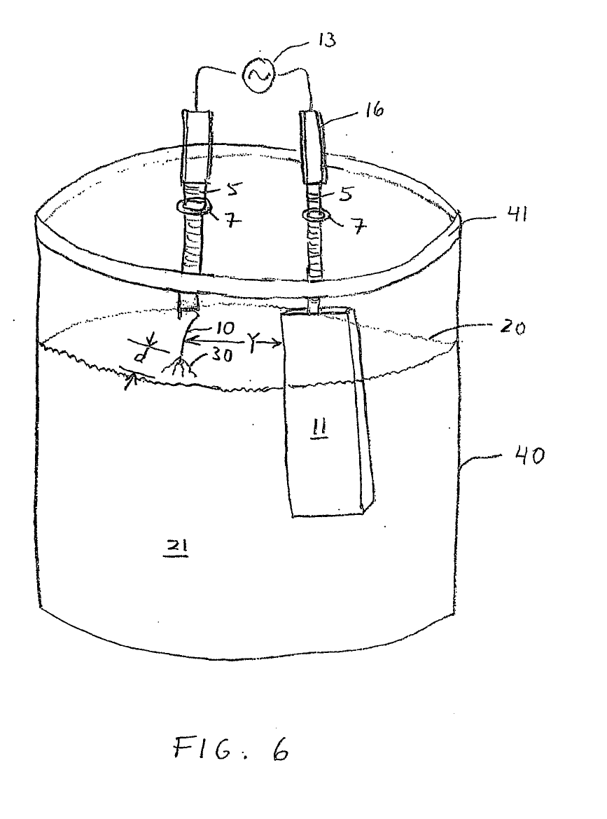

### DETAILED DESCRIPTION OF THE PREFERRED EMBODIMENTS

The present invention can be utilized to pretreat or condition any liquid that is involved and/or will be involved in a chemical, biological and/or physical process. However, the present invention, has found particular usefulness in the pretreating, conditioning, and/or treatment of water. In particular, by following the teachings of the present invention, the apparent reducing or reduction potential of water can be substantially increased by, for example, lowering the measured pH of the water. In this regard, under ordinary aqueous conditions, water molecules tend to dissociate into hydronium ions (represented as H⁺ or H₃O⁺) and a hydroxyl radical (represented as OH⁻) such that an equilibrium is established represented by the chemical equation:

H₂O [symbol] H⁺_{(aq)}+OH⁻_{(aq)}

The equilibrium for neutral water occurs when the concentration of hydronium and hydroxyl ions are each at a level of 10⁻⁷ per unit volume or approximately 1 part per billion. This minute level of concentration is conventionally expressed as a pH number of 7 (which is the negative log, i.e. power of 10) that is mathematically equivalent to such small numbers. A solution becomes more acidic as the concentration of H⁺ increases. Traditionally, for example, if the concentration of H⁺ increases from one part per billion (10⁻⁷) to one part per thousand (10⁻³) the pH changes from 7 to 3. By convention, acidic solutions are those where the pH is below 7 and alkaline solutions are those where the pH is above 7 and a neutral solution occurs at a pH of 7. However, pH can be a function of the measurement tools used to determine pH and care may need to be taken when interpreting certain pH readings from certain instruments.

The present invention has been shown to have a significant impact on the structure and/or compositions of liquids. For example, the present invention has been shown to have a significant impact on water as evidenced by the significant changes in measured pH and measured conductivity. Specifically, An AR20 pH/mV/° C./Conductivity meter from Accumet Research (Fisher Catalog No. 13-636-Anzo 2000/2001 catalog) communicated with water treated according to the present invention through a temperature probe and a pH electrode. More details of the temperature probe and pH electrode can be seen in FIG. 5.

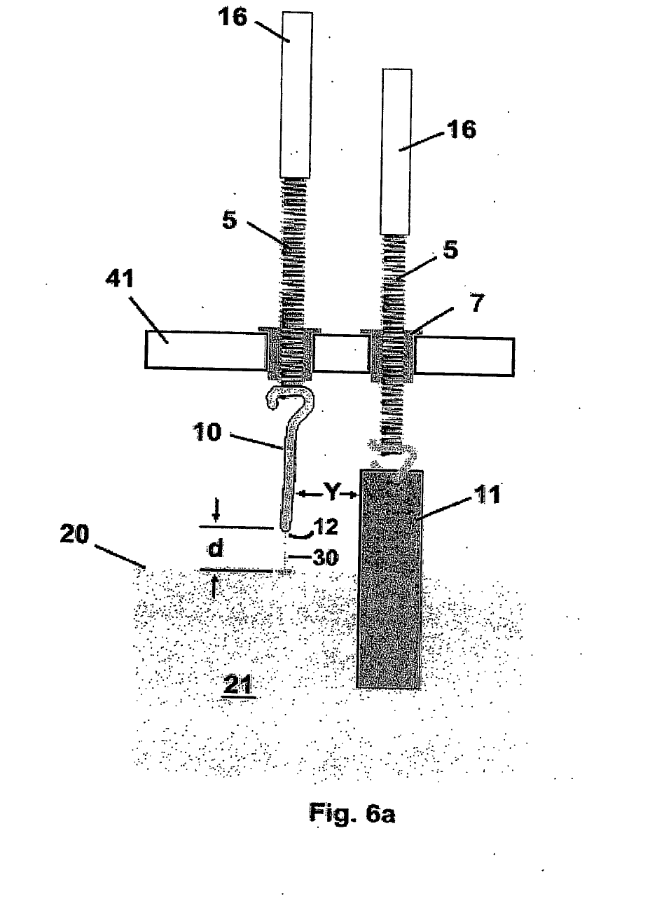

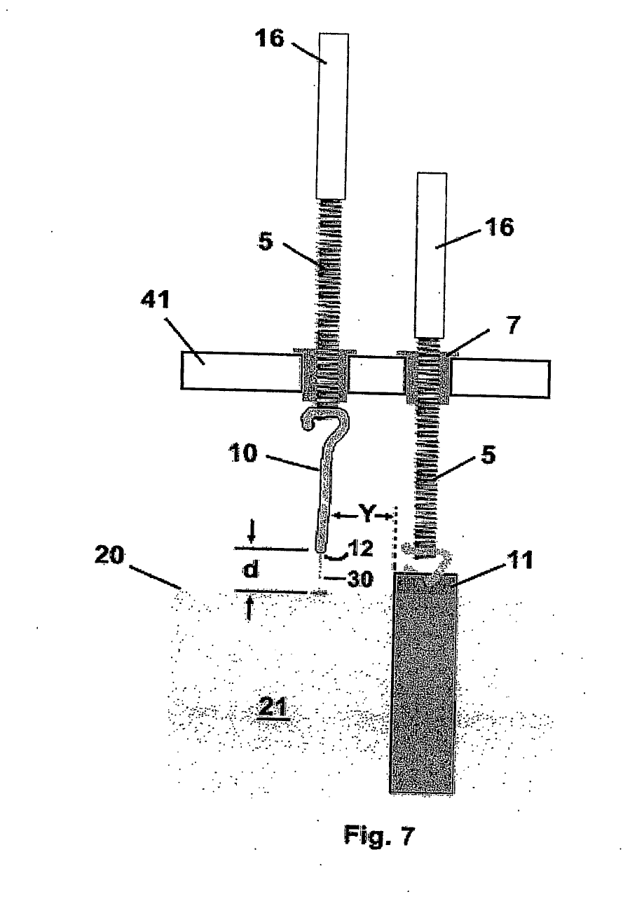

FIGS. 6 and 6a show a first embodiment of the invention whereby a 1.5 gallon container or reaction vessel 40 contains about 1 gallon of substantially pure water 21. The vessel 40 is made of plastic, such as polycarbonate plastic. A lid 41 made substantially of the same material acts as a cover for the vessel 40. The vessel measures about 9¼ inches high by about 6 3/4 inches wide. A first electrode 10 is removably attached to the top 41 and is electrically connected to a power source 13, which is in turn connected to a partially submerged second electrode 11. The preferred compositions of the electrodes 10 and 11 in this embodiment are metallic. Preferable compositions of electrodes 10 and 11 thus far have included: silver, zinc, copper, titanium, and platinum. Electrodes 10 and 11 can be of similar composition or substantially dissimilar composition (e.g., one can be copper or silver and the other can be zinc). In the embodiment shown in FIGS. 6 and 7, the approximate distance between the electrodes 10 and 11 is about 1.5 inches. In this embodiment, the electrode 11 is partially submerged below the surface 20 of water 21. The electrode measures about 1 inch wide by 4 inches high by about 1 mm thick. In this embodiment, the electrode 11 has about 3 inches of its length submerged below the surface 20 of the water 21. The electrode 10 has a tip 12 which is located approximately 1-1.5 cm above the surface 20 of the water 21. An AC power source 13, comprising a transformer, electrically connects the electrode 10 to the electrode 11 through the water 21. When utilizing an alternating current transformer, transformer ratings from a few thousand volts to a few tens of thousands of volts are acceptable. In this particular embodiment, transformers from about 5,000 to about 20,000 volts and about 20 to about 60 milliamps were utilized. A capacitor attached to the transformer can be utilized to adjust the power factor (e.g., in order to bring the voltage and current sine waves of AC power into phase with each other) if needed. The electrodes 10 and 11 can be made of any metal(s), but a portion of the composition of electrode 10, as well as a portion of electrode 11, should be expected to become part of the liquid (e.g., water) solution (e.g., a few parts per million). Accordingly, the selection of the composition of the metal electrode(s) may be important depending upon the ultimate use of the water. The embodiments shown in FIG. 6, 6a, and 7 show electrodes 10 and 11 suspended from a conductive material 5 (in this example a threaded brass rod) and held within either an electrically insulating or electrically conducting material 7 (in this case an electrically conductive threaded brass nut 7). The portions 16 attached to the conducting portions 5 are insulating polymer rods which cover an end portion of the conductive rods 5, thus permitting the height of the electrodes 10 and 11 to be adjusted relative to the surface 20 of the water 21.

When starting with a substantially pure water 21 to be treated, the required distance “d” between the tip 12 of electrode 10 and the surface 20 are a function of the required breakdown electric field of air (e.g., something less than about 30 kV/cm because the air is somewhat humid). The distance “d” can not be so small that Taylor cones from the surface 20 of the water 21 form on the electrode 10. Further, the distance “Y” between the electrodes 10 and 11 must be greater than the distance “d” between tip 12 and water surface 20 so as to prevent arcing or corona formation between the electrodes 10 and 11. Further, the distance “Y” is a function of the conductivity of the water 21 (e.g., the water 21 needs to be sufficiently conductive to permit the surface 20 of the water 21 to effectively function as one electrode in the formation of the corona arc 30). In other words, the water 21 needs to have sufficient conductance so that the electrode 11 is close enough to the surface of the water 20 directly under the tip 12 of electrode 10 to permit a corona arc 30 to be generated between the tip 12 of electrode 10 and the water surface 20. For example, for a power source or AC transformer rating from about 5000 volts to about 20,000 volts, and a constant amperage rating of about 20-100 milliamps, the electrodes should be separated by about 3-6 cms. However, the size of the electrodes, shape of the electrodes, distance between the electrodes, distance between electrode tip 2 and the surface of the water 20, power source, etc., are all interrelated. Moreover, in the preferred embodiments of the invention, the goal will be to create a corona discharge or plasma arc 30 between the tip 12 of electrode 10 and the surface 20 of the liquid 21. When such a corona arc discharge is created, any liquid, in this case, water, can be desirably modified.

FIG. 7 shows a slightly different electrode configuration whereby the electrode 11 is substantially completely submerged below the surface of the water. Either electrode configuration shown in FIG. 6 or in FIG. 7 is adequate, so long as the electrode 10 located above the surface 20 of the water 21 is positioned such that the breakdown electric field between the tip 12 of the electrode 10 and the water surface 20 is achieved. Further, the electrodes 10 and 11 can be electrically connected to the brass rods 5 by any suitable electrical connection. Electrically conductive wires have been found to be satisfactory.

FIGS. 6 and 6a shows the electrode arrangement that was utilized to generate the data in Table 1. In this example, the composition of the electrodes 10 and 11 were both copper. The diameter of electrode 10 was about 1 mm; and the size of electrode 11 was about 1 inch by 4 inches by about 1 mm thick. The power source 13 comprised an AC transformer. Specifically, the transformer was Franceformer, Part No. 48765 rated for 120 VAC input and for 10,500 VAC maximum output at 30 milliamps.

As is shown in Table 1, at time t=0, the measured conductivity of the water was about 0.232 (i.e., substantially pure water). The measured pH of the water at t=0 was about 7. After only about five minutes of operation, the conductivity of the water had increased to 11.5 (TDS). “TDS” is known as “total dissolved solids” and is one of the units of measure from the Accumet meter described herein. The pH had dropped nearly three orders of magnitude from 7 to about 4.37.

TABLE 1
Copper

| min | Conductivity | pH |
|---|---|---|
| 0 | 0.232 | 7.01 |
| 5 | 11.5 | 4.37 |
| 10 | 25.2 | 4.03 |
| 15 | 33.2 | 3.93 |
| 20 | 45.7 | 3.8 |
| 25 | 57.6 | 3.69 |
| 30 | 68.1 | 3.58 |

Table 2 shows similar results using zinc electrodes rather than copper electrodes. In this regard, the same set up of FIGS. 6 and 6a was utilized to generate the data in Table 2. Likewise, after only five minutes of operation, one gallon of water had its conductivity increased to 14.4 (TDS) and its pH dropped nearly three orders of magnitudes from 7.01 to 4.29. It is noted from Table 1 that the greatest drop in pH occurs within the first 5-10 minutes of the creation of the corona 30. However, the conductivity appears to continue to increase. The data suggests that initially, free electrons may be being forced into the solution causing an increase in the concentration of electrons. However, conductivity continues to increase because, for example, additional metal atoms may be being provided to the solution from one or both of electrodes 10 and/or 11. In this regard, without wishing to be bound by any particular theory or explanation, it is possible that the concentration of electrons in water due to the corona discharge 30 is initially quite high, however, this concentration may level off after only a few minutes. However, conductivity continues to increase, which suggests metallic-charged carriers may also be entering the solution.

TABLE 2
Zinc

| min | Conductivity | pH |
|---|---|---|
| 0 | 0.232 | 7.01 |
| 5 | 14.4 | 4.29 |
| 10 | 33.8 | 3.87 |
| 15 | 39.9 | 3.78 |
| 20 | 53.5 | 3.69 |
| 25 | 62.9 | 3.59 |
| 30 | 78.1 | 3.48 |

Again, without wishing to be bound by any particular theory or explanation, it is possible that the large change in conductivity, as well as a corresponding large change in pH, is due to the presence of solvated or hydrated electrons. Whether or not this is the case, clearly significant changes have occurred in the water. Of course, controlling the pH is readily achievable by a combination of electrode combination, power density (e.g., applied electric field strength), and time. In the examples set forth in Tables 1 and 2, the pH dropped rapidly in the first few minutes. This suggests that a small amount of time results in a great change in the structure of water.

Example 1: A configuration according to FIGS. 6 and 6a was utilized for a set of zinc electrodes and a set of silver electrodes. In particular, the silver electrode 10 comprised a double twisted silver wire having an initial thickness of about 1 mm. The silver plate 11 measured about 1 inch by 4 inches by 1 mm thick. The transformer utilized was Franceformer, Part No. 10530P rated for 120 VAC input and for 10,500 VAC maximum output at 30 milliamps. Runs were performed wherein conductivity and pH were measured as a function of time. Additionally, a third example using a different transformer, namely a 60 milliamp transformer (Franceformer, Part No. 9060PE, rated for 120 VAC input and 9,000 VAC maximum output at 60 milliamps) was also used.

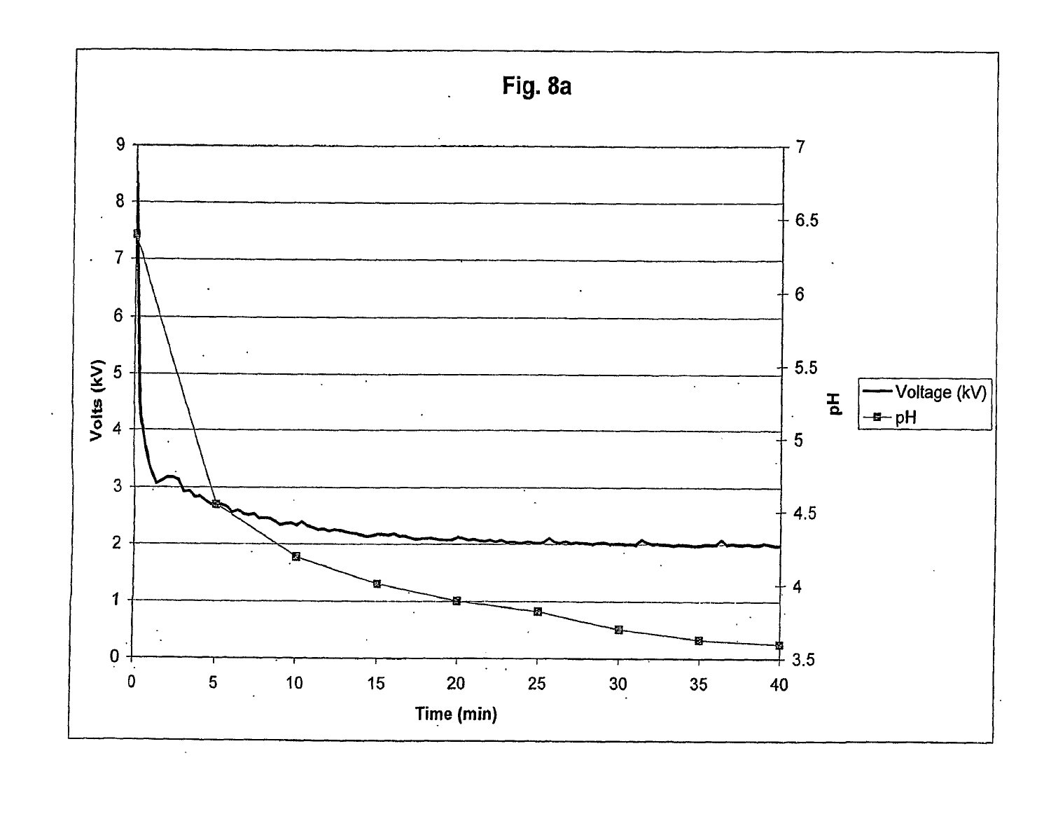

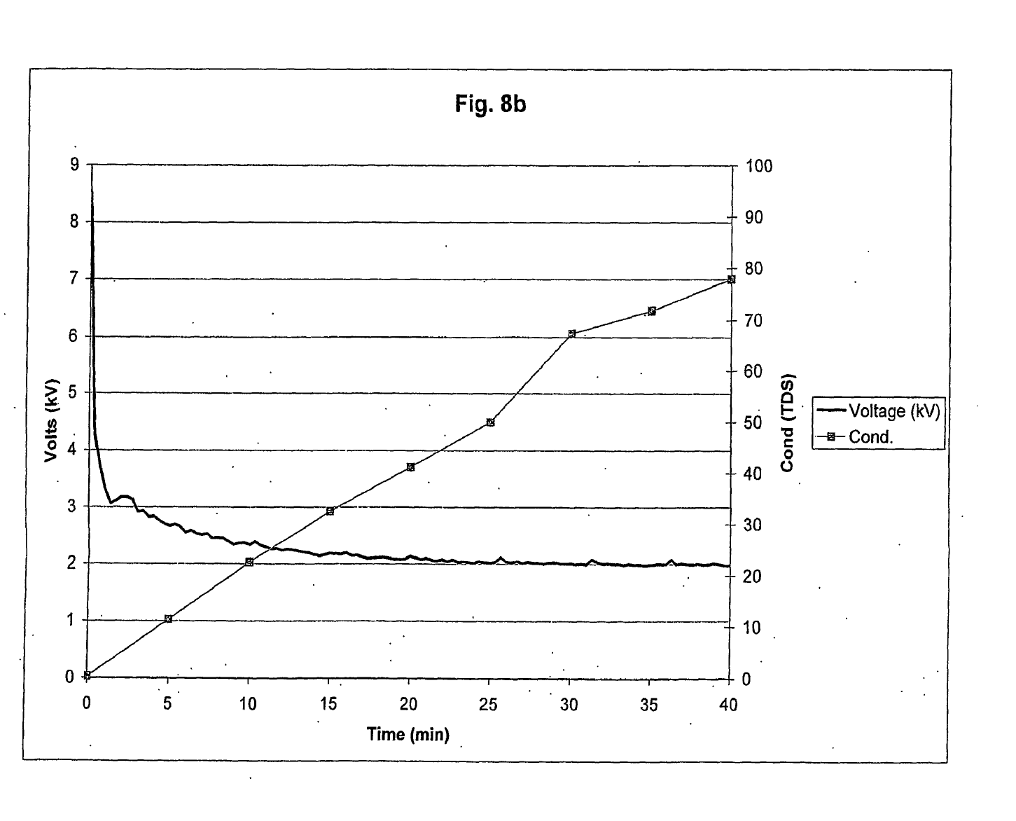

The results of these corona arc water treatments are shown in FIGS. 8-11.

FIG. 8a shows the measured pH as a function of time utilizing silver as electrodes 10 and 11. FIG. 8b shows measured conductivity as a function of time and using the same silver electrodes. The ppm of the sample was about 4.7.

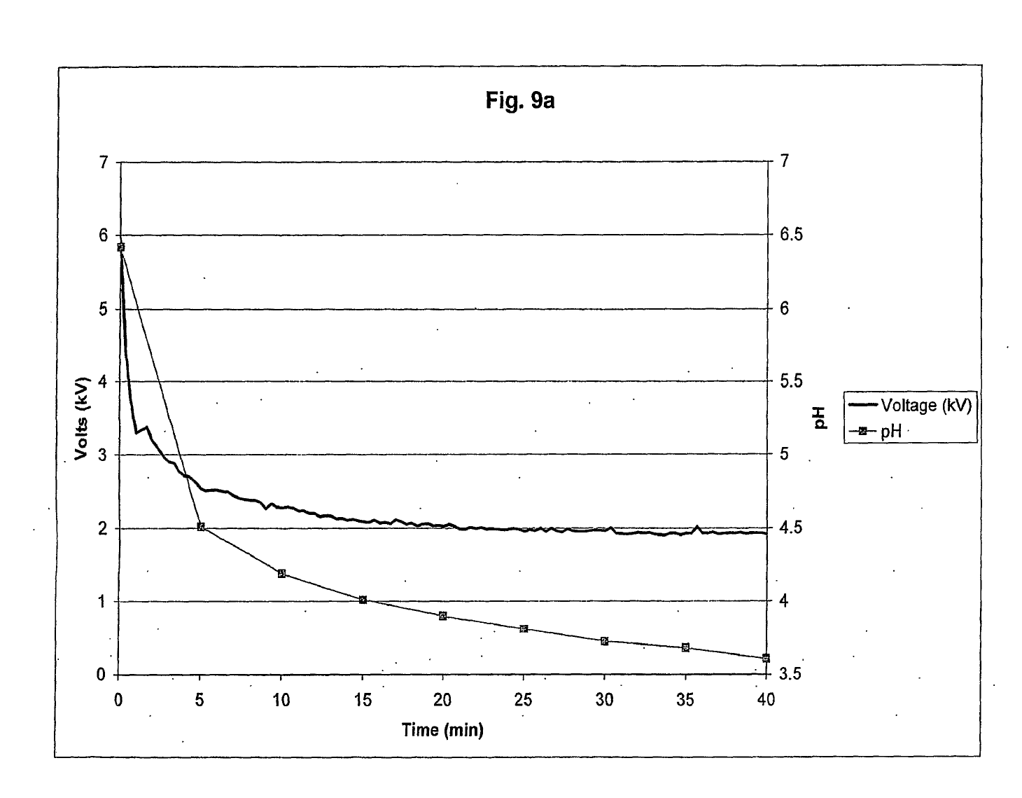

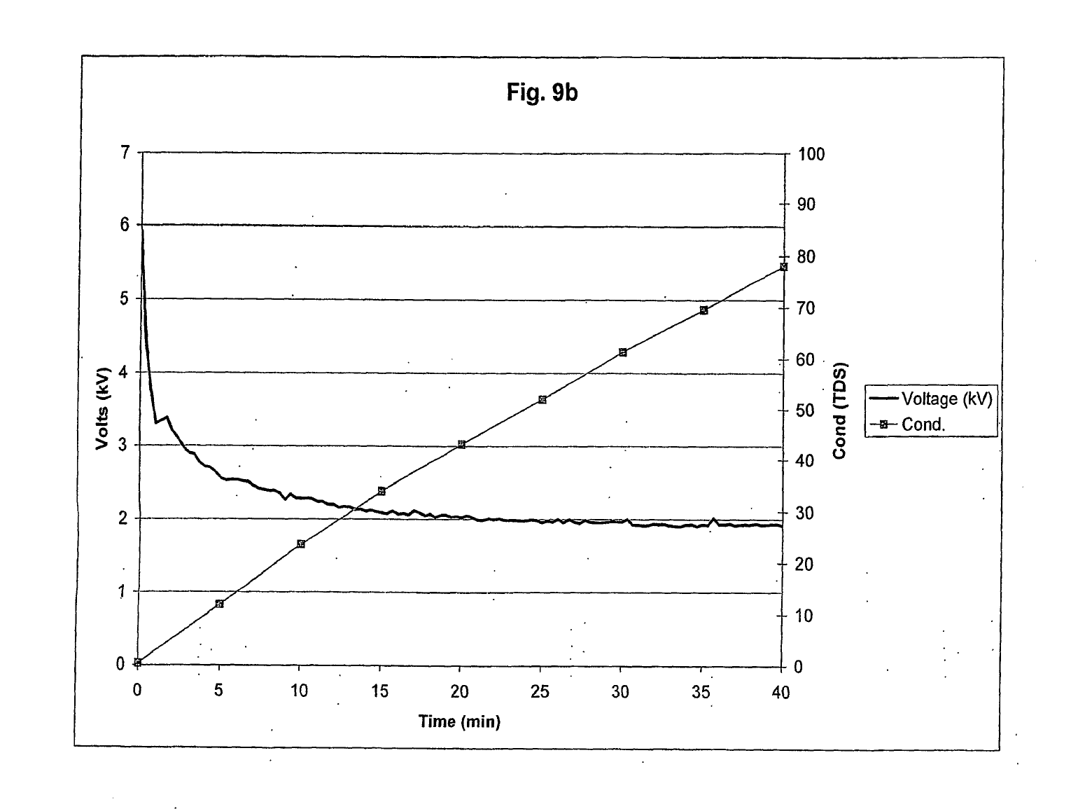

FIG. 9a shows pH as function of time utilizing the same experimental setup in FIGS. 6 and 6a, with a 30 milliamp transformer; and FIG. 9b shows conductivity as a function of time for the same experimental conditions. The ppm of the sample was about 4.3.

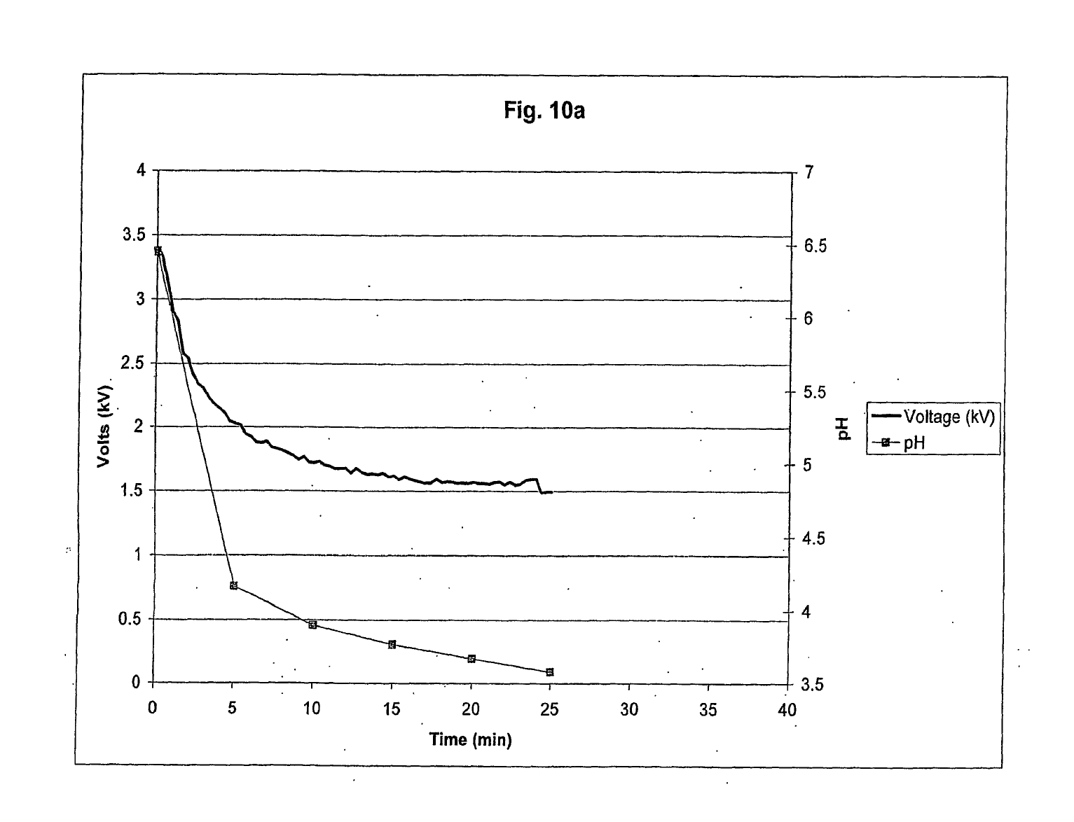

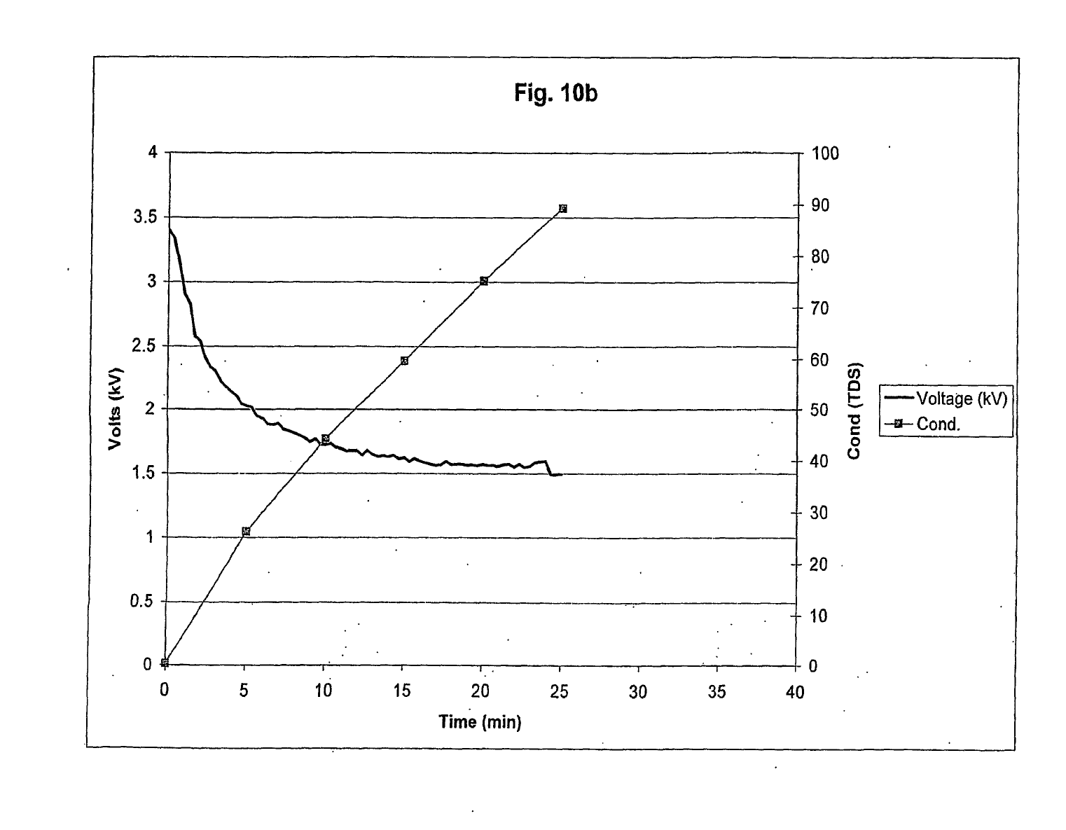

In contrast, FIGS. 10a and 10b show the results of a similar setup as shown in FIGS. 6 and 6a except that the transformer was now a 60 milliamp transformer with a voltage output rating of 9,000 VAC. The ppm of the sample was about 2.5.

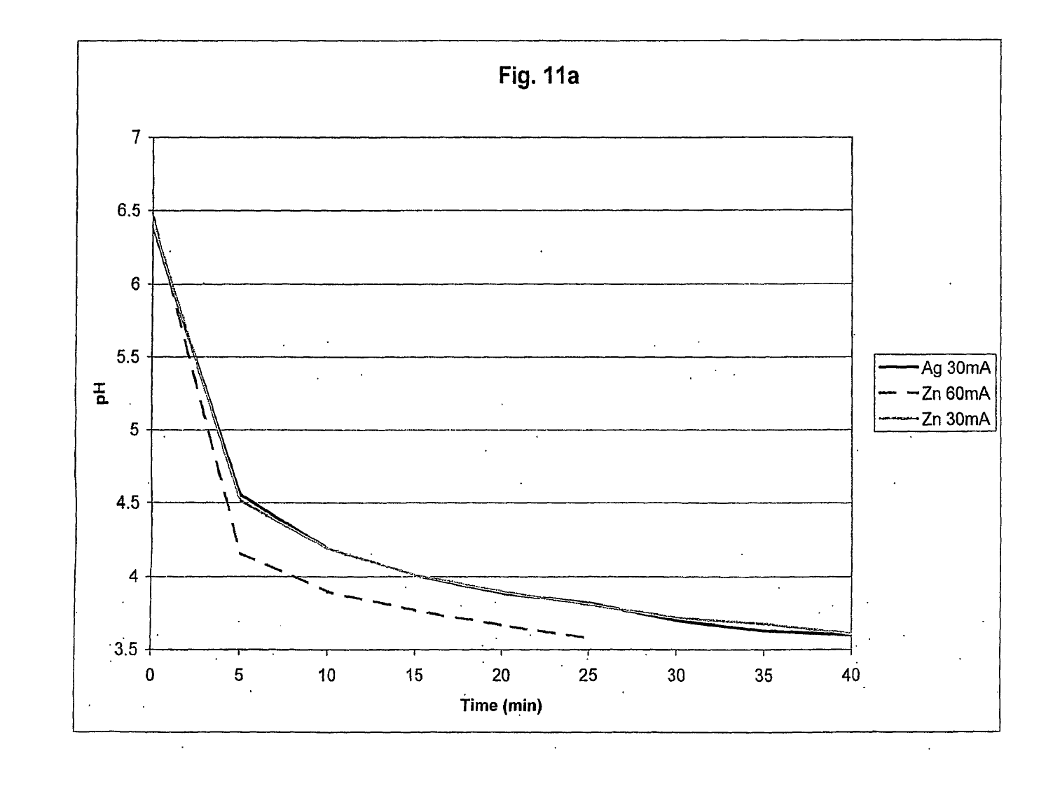

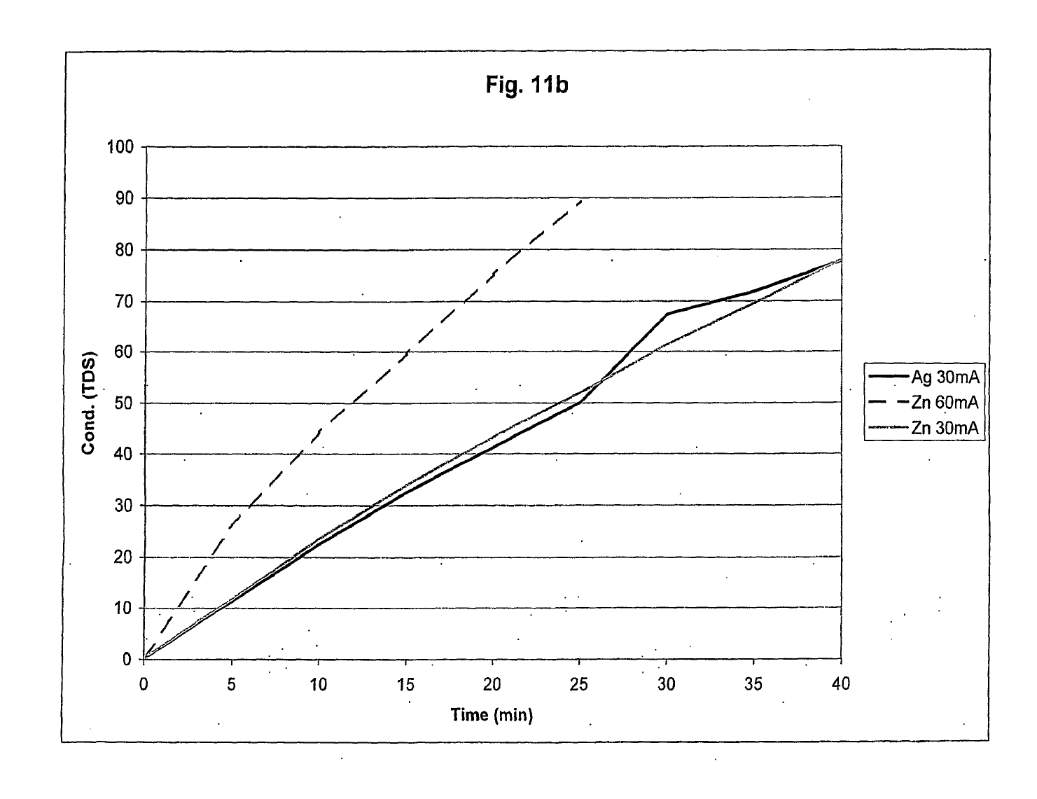

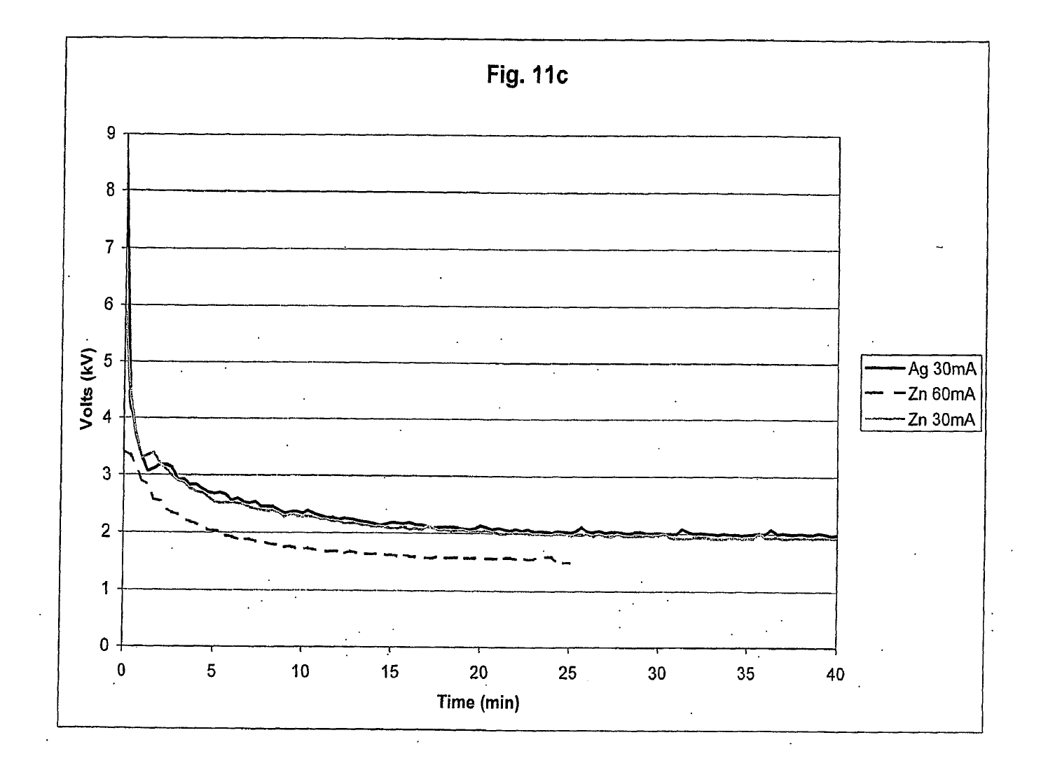

FIGS. 11a, 11b, and 11c show pH comparisons, conductivity comparisons, and voltage comparisons, respectively for the data in FIGS. 8, 9, and 10.

It is clear from all of the examples utilizing the experimental configuration of FIGS. 6 and 6a that the measured conductivity and measured pH of water are significantly impacted after short exposures to the corona arc 30 made according to the teachings of the present invention. The surface 20 of the water 21 is being directly exposed to the corona plasma 30 and is effectively functioning as an active electrode. While active electrodes are typically associated with surface treatments, the water is clearly being affected at more than just the surface. In particular, the measured conductivity and pH data was carefully obtained from within the treated water samples and it is believed that the water samples were substantially homogeneous in their pH and conductivity measurements. Accordingly, it is clear from these examples that the direct exposure of the corona plasma 30 to the surface 20 of the water 21 resulted in significant changes to the experimental measurements given by the water.

Atomic absorption spectroscopy was conducted on each of the water samples shown in FIGS. 8-11. In particular, atomic absorption spectroscopy was conducted by an atomic absorption spectrometer. The analysis of the metal content in the metal compositions of this invention may be performed by (acetylene) flame-atomic absorption spectroscopy (FAAS), inductively coupled plasma (ICP), atomic emission spectroscopy (AES) or other techniques known to one of ordinary skill in the art to be sensitive to silver in the appropriate concentration range. If the particles of the metal composition are small and uniformly sized (for example, 0.01 micrometers or less), a reasonably accurate assay may be obtained by running the colloid directly by atomic absorption or ICP/AES. This is because the sample preparation for atomic absorption spectroscopy ionizes essentially all of the metal allowing its ready detection.

If the compositions comprise particles as large as 0.2 micrometers, it is preferred to use a digestion procedure. The digestion procedure is not necessarily ideal for metal compositions that may have been manufactured or stored in contact with halides or other anionic species that may react with finely divided metal, or combined with protein or other gelatinous material. An embodiment of the digestion procedure is as follows:

1. With regard to silver/water composition, take a 10 ml aliquot of a thoroughly mixed or shaken silver/water composition to be analyzed, and place it in a clean polycarbonate bottle or other container of suitable material (generally, the bottle) with a tight fitting lid. A size of 3-100 ml is preferred.

2. With a micropipette or dropper, add 0.1 ml of nitric acid, reagent grade to the silver/water composition in the bottle.

3. With the lid of the bottle tightly in place, heat the silver/water composition to at least about 80° C., and preferably about 90° C.-100° C. with mild agitation for a time sufficient to dissolve the metal—dissolution is essentially instantaneous.

4. Allow the resulting mixture to cool to room temperature with the lid in place. Shake the bottle thoroughly. This digestion procedure also dissolves any metal oxide surface layer that may be present on the metal particles.

5. Utilize atomic absorption spectroscopy, ICP/AES, or equivalent means to analyze the metal content of the metal/water mixture. Preferably, one will utilize a freshly prepared standard or standards, preferably prepared according the equipment manufacturer's instructions, with appropriate dilution as needed.

6. When reporting results, one must take into account all dilutions during preparation, including the 1% dilution caused by addition of the nitric acid. Similar acids and techniques can be used for the other metal/water compositions disclosed herein.

The metal concentration of the metal/water compositions of the present invention corresponding to the data in Tables 1 and 2, as well as FIGS. 8-11, was determined using a Perkin Elmer AAnalyst 300 atomic absorption (AA) spectrometer. Samples of the inventive metal/water compositions were digested according to the procedure described above.

The Perkin Elmer AAnalyst 300 system consists of a high efficiency burner system with a Universal GemTip nebulizer and an atomic absorption spectrometer. The burner system provides the thermal energy necessary to dissociate the chemical compounds, providing free analyte atoms so that atomic absorption occurs. The spectrometer measures the amount of light absorbed at a specific wavelength using a hollow cathode lamp as the primary light source, a monochromator and a detector. A deuterium arc lamp corrects for background absorbance caused by non-atomic species in the atom cloud.

The results of atomic absorption spectroscopy showed that less than 2 ppm silver, copper, and zinc were present in the water treated according to the disclosure herein.

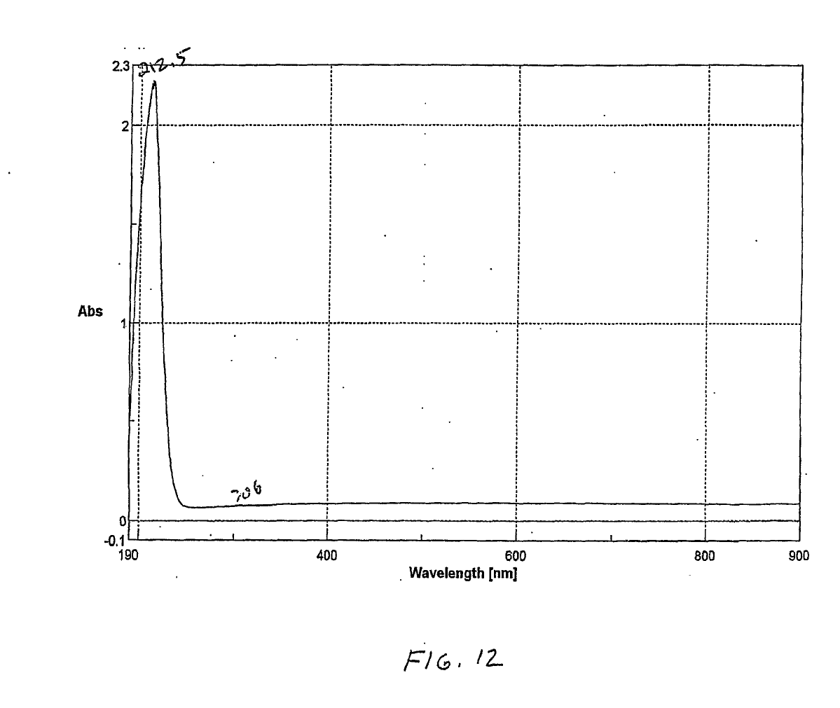

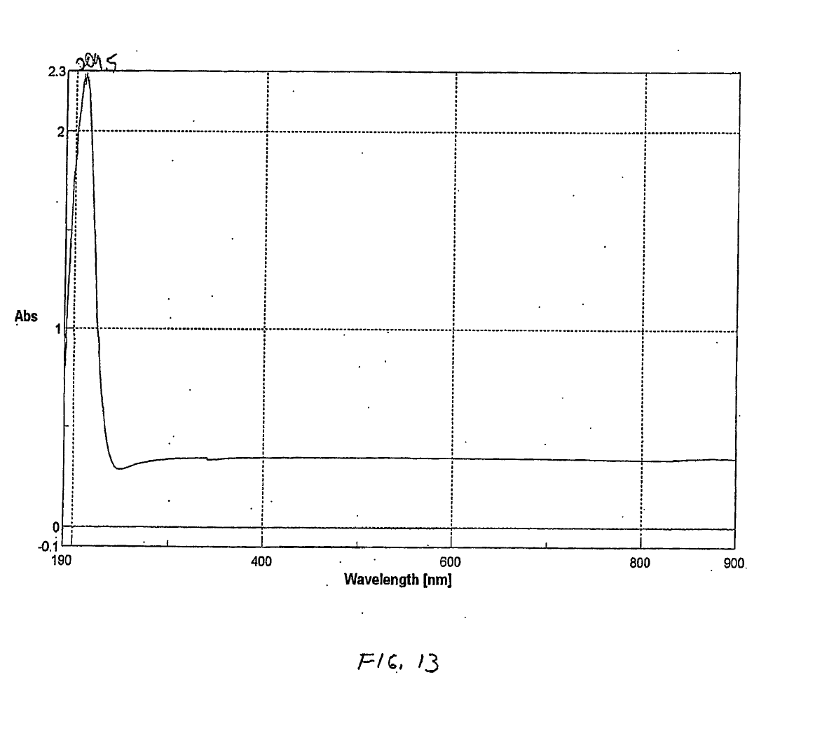

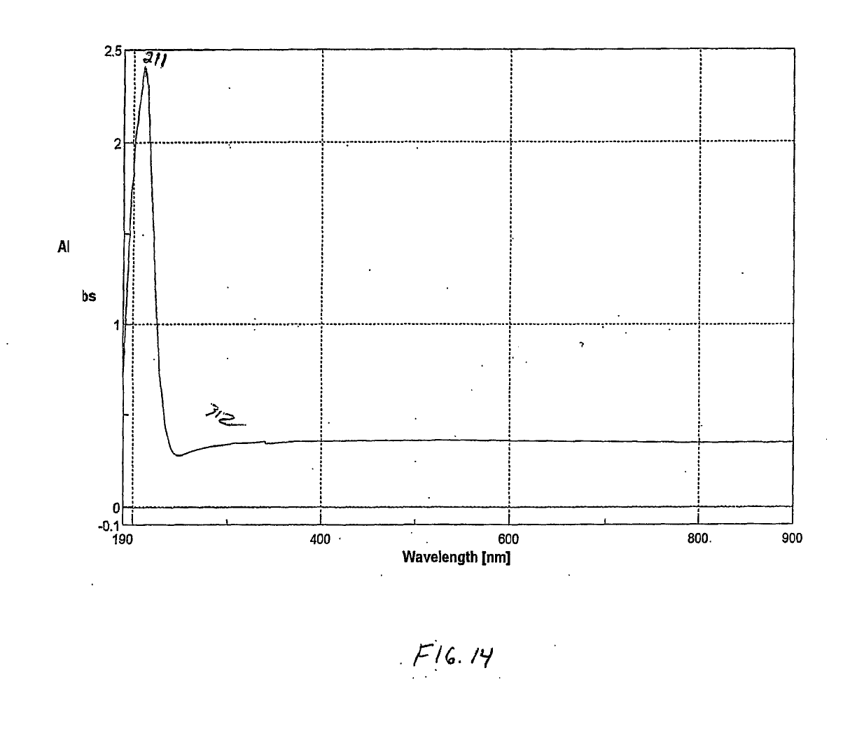

Further, UV-Vis spectroscopy was performed upon three different water samples. The UV-Vis spectra of FIG. 12 corresponds to the data in FIGS. 8a and 8b; the UV-Vis Spectra of FIG. 13 corresponds to the samples of FIGS. 9a and 9b; and FIG. 14 corresponds to the samples of FIGS. 11a and 11b. The data in FIGS. 12-14 were all generated by a UV-Vis spectrometer (Jasco MSV350). The instrument was set up to support measurement of low-concentration liquid samples using a 10 mm×10 mm fizzed quartz cuvette. Data was acquired over the above wavelength range using both a photo multiplier tube (PMT) and a Photo Diode detector with the following operational parameters: a bandwidth collection of 2 nm, a resolution of 0.5 nm; and a water baseline background subtracted from the generated spectra. In this regard, the UV-Vis signature for pure water was subtracted from the generated spectra so as to show more representative spectral signatures for the silver/water mixture.

With regard to FIG. 12, the initial absorption of the sample was so high that it did not fit on to the absorption scale. Accordingly, the sample was diluted with regular distilled water in a one-to-one ratio. That brought the absorption down to around 2 (see FIG. 12). Likewise, the zinc electrodes used to generate the UV spectra of FIGS. 13 and 14 also created absorption spectra that were off the scale. These samples were also diluted one-to-one with regular distilled water to create absorption peaks also around 2. The data in Tables 1 and 2 and shown in FIGS. 8-14 all suggest that the structure of liquids, in this case liquid water, can be significantly impacted in a short amount of time by following the teachings of the present invention.

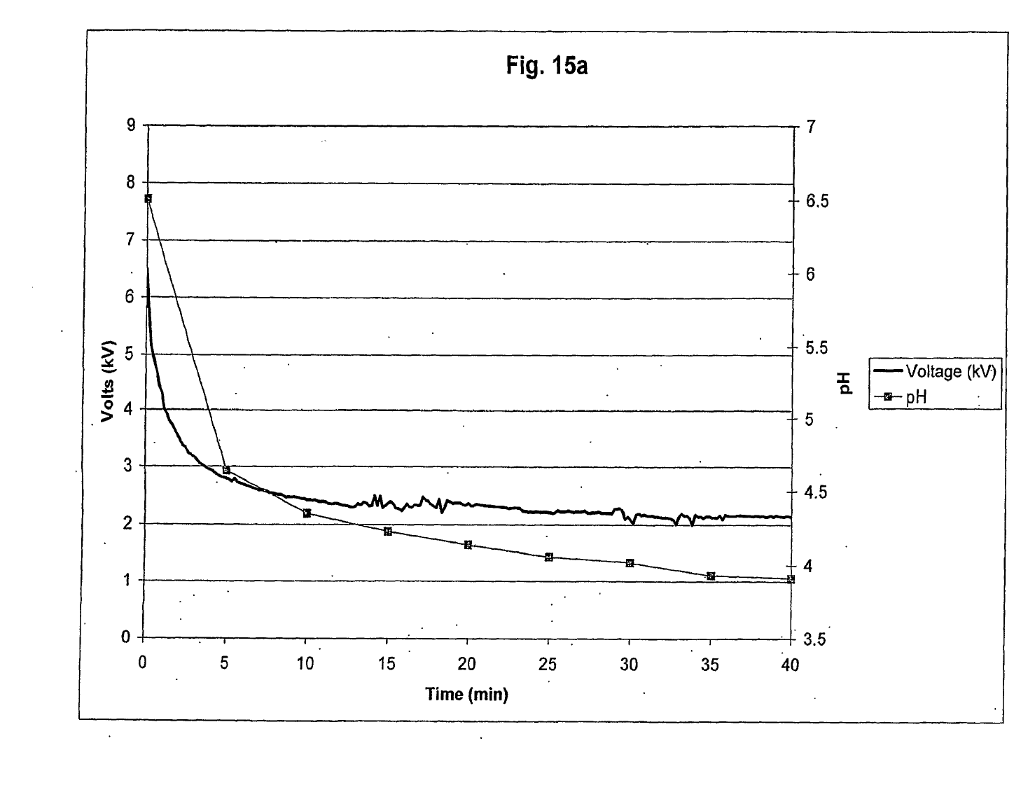

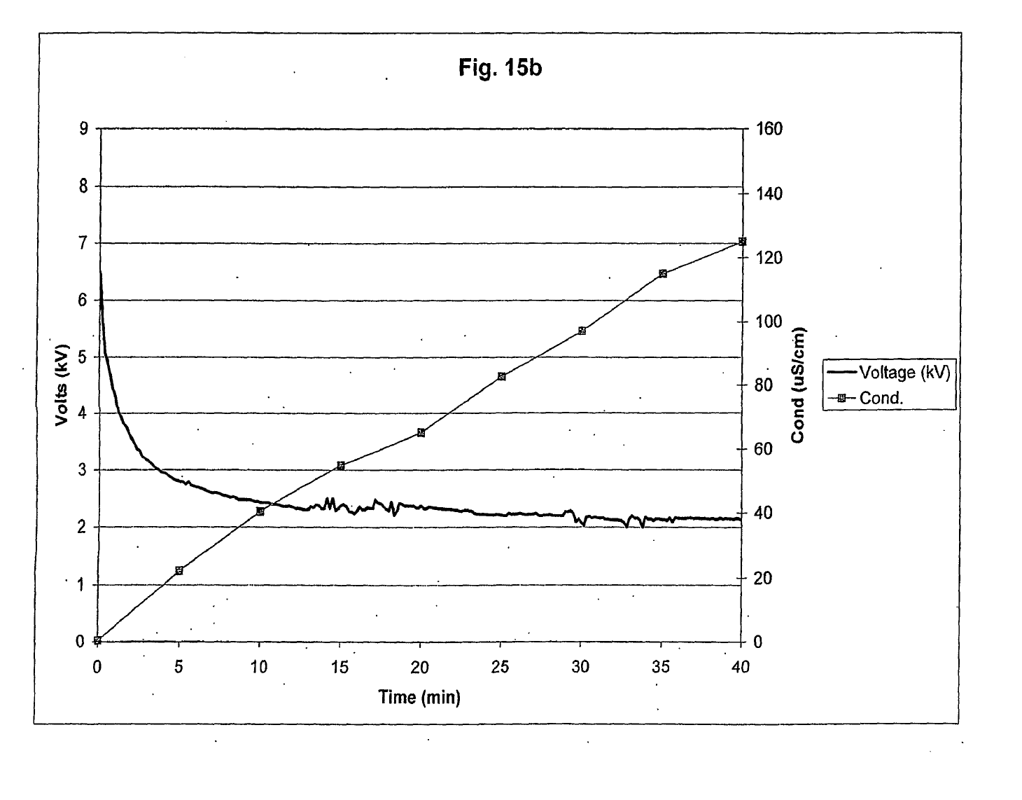

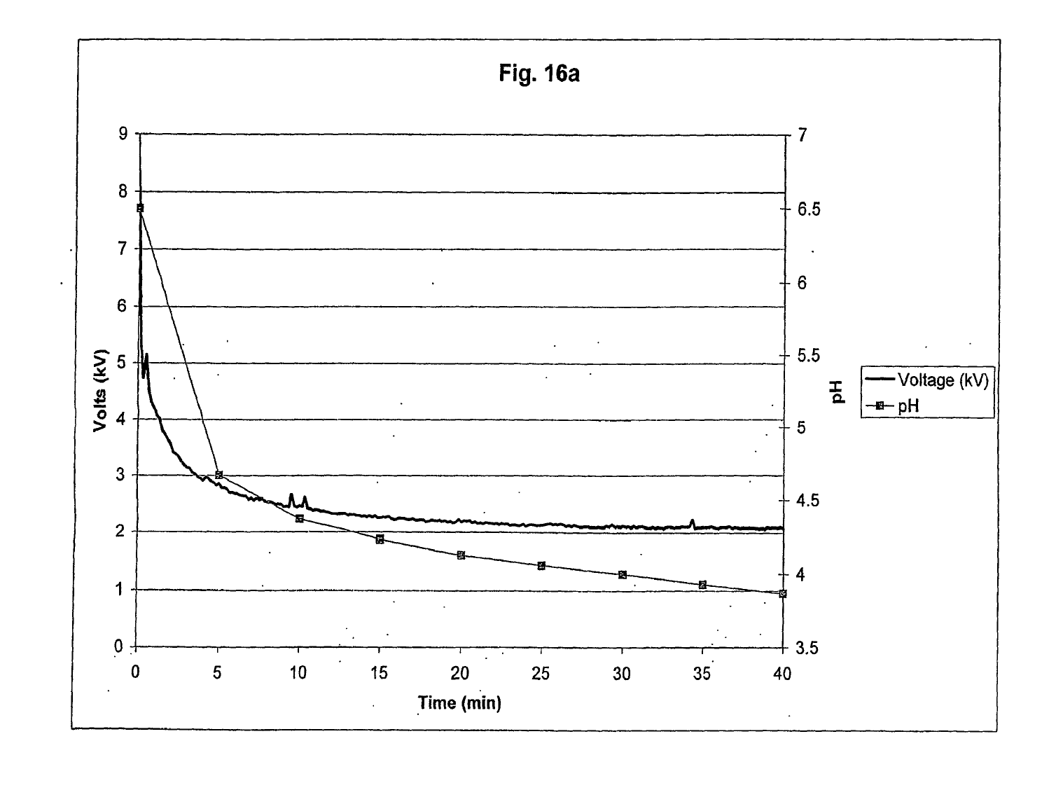

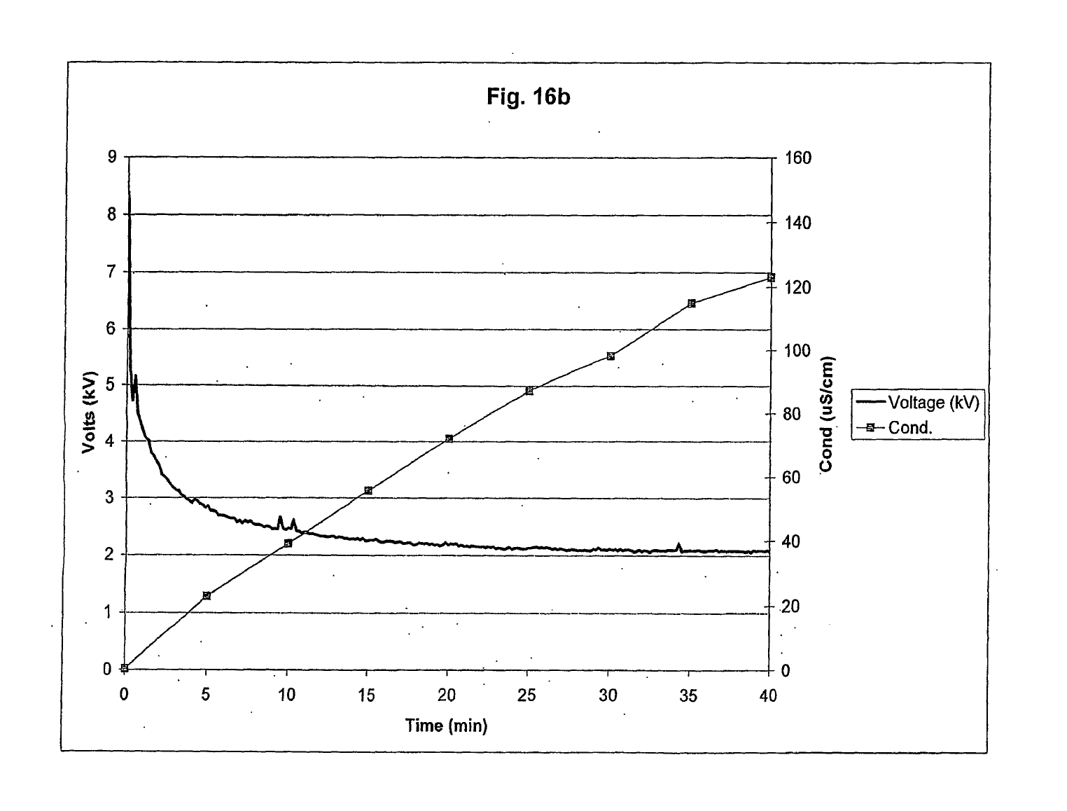

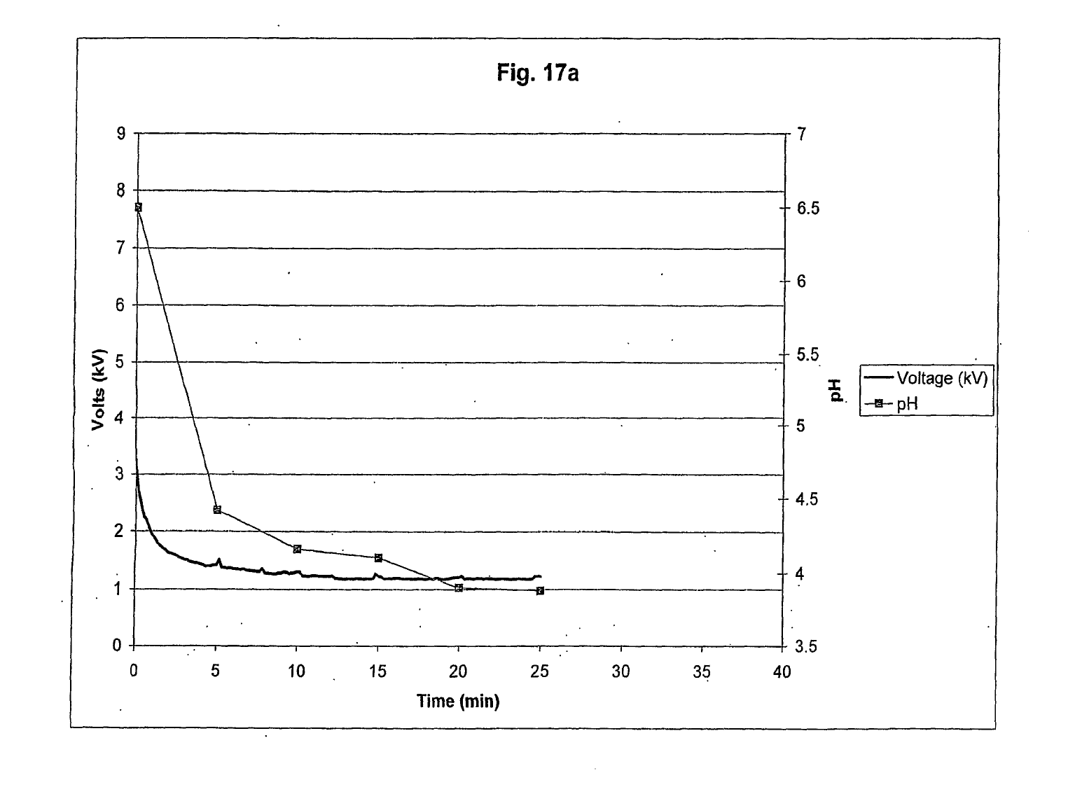

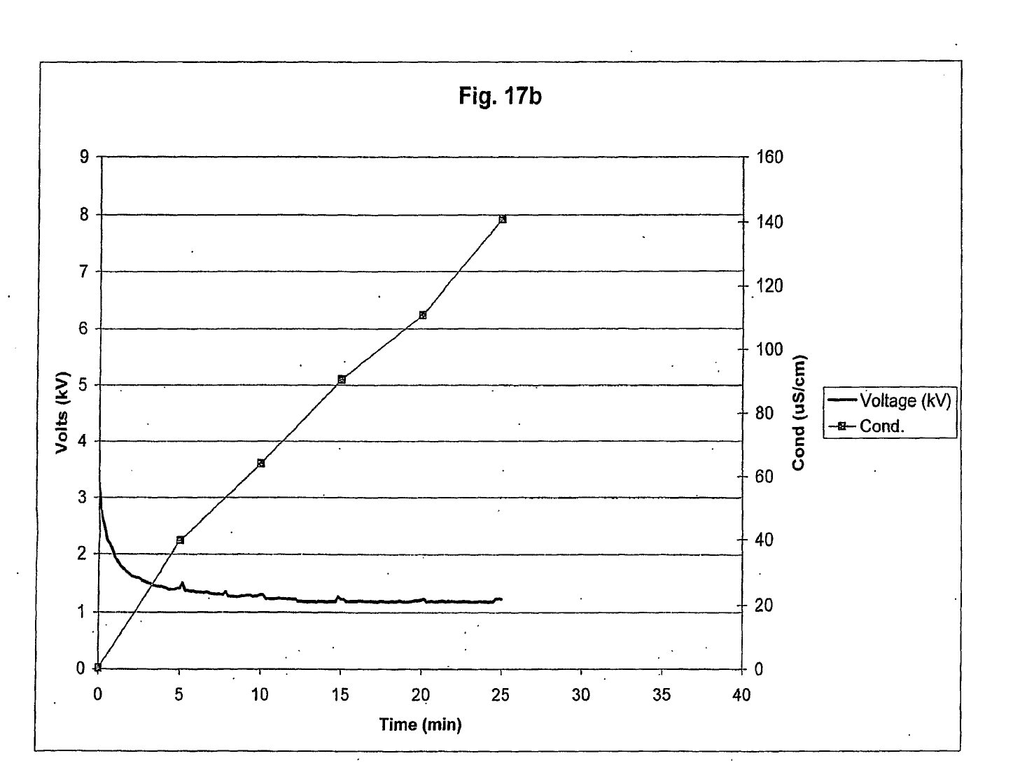

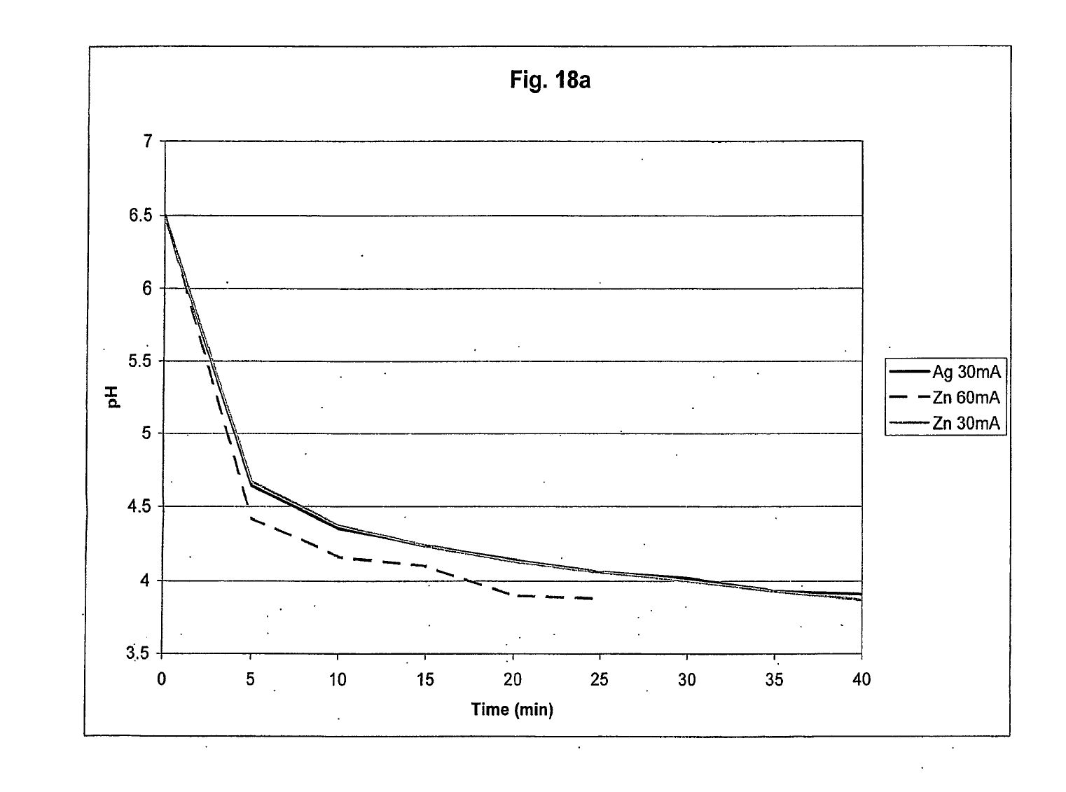

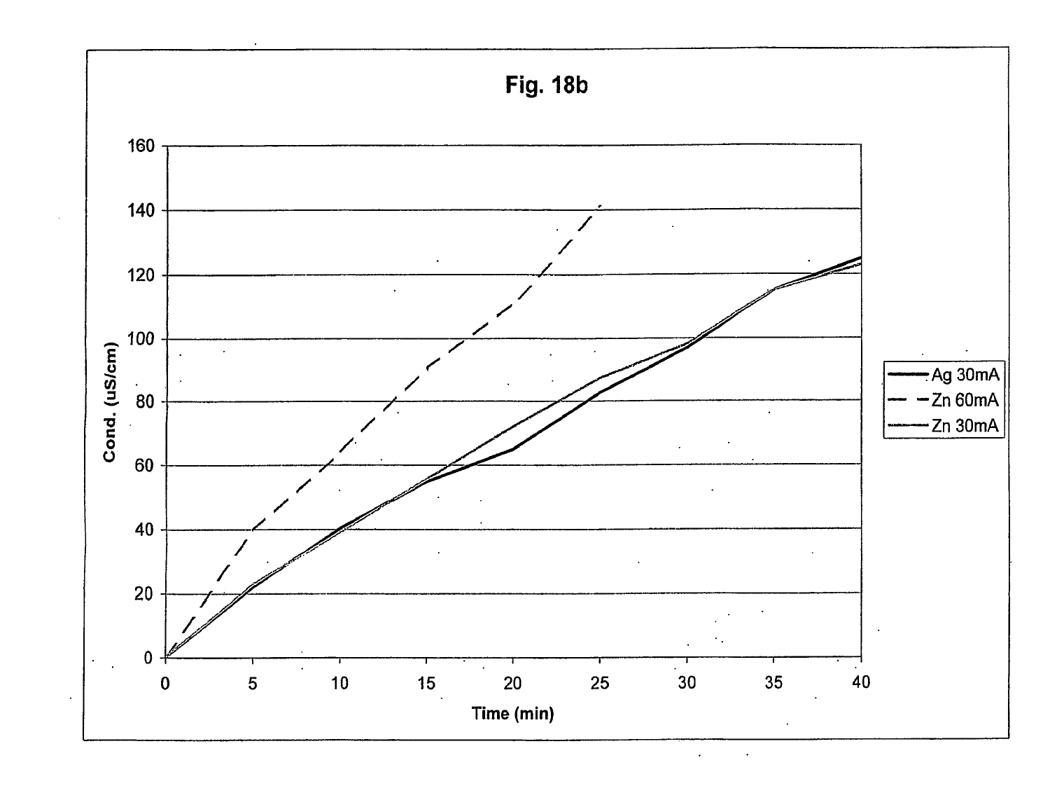

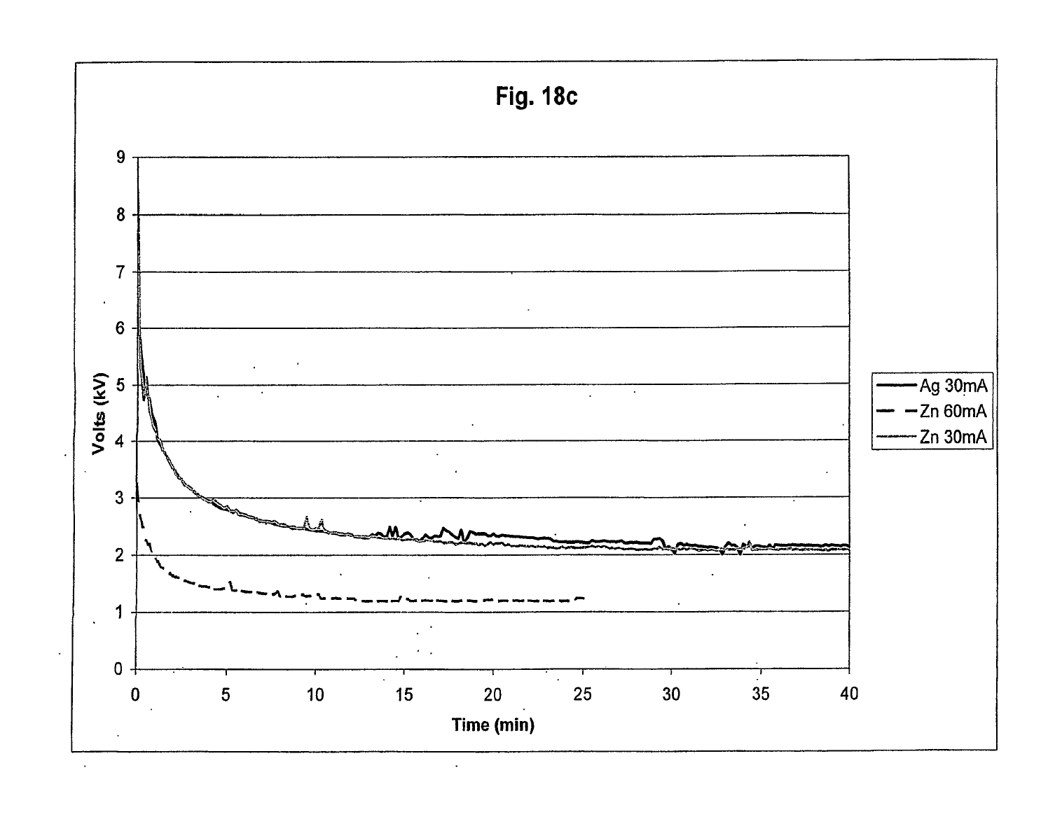

Three additional examples were performed according to the configuration shown in FIGS. 6 and 6a and with parallel processing to that processing used to generate the data of FIGS. 8-11. In particular, the generated data is set forth in FIGS. 15-18. The only difference in data reporting is that the conductivity measurements were performed using μS/cm rather than “TDS”.

1. A method for treating liquid comprising:
a) locating at least one first electrode at least partially below a surface of said liquid;
b) locating at least one second electrode above said surface of said liquid;
c) providing power between said first and second electrodes such that a corona discharge plasma is created between at least a portion of said second electrode and at least a portion of said liquid surface; and
d) applying said power for a sufficient time so as to affect at least one of the composition and the structure of said liquid.

2. A method for changing at least one physical property of water comprising:
a) locating at least one first electrode below at least partially below surface of said water;
b) locating at least one second electrode above said surface of said water;
c) applying power in a sufficient amount so as to create a corona discharge plasma between said second electrode and at least a portion of said surface of said water; and
d) continuing the applying of said power for sufficient time so as to raise the conductivity of said water.

3. The method of claim 2, wherein said method occurs in a batch process.

4. The method of claim 2, wherein said method occurs in a semi-continuous process.

5. The method of claim 2, wherein said method is substantially continuous.
